(19) United States
(12) Patent Application Publication
(10) Pub. No.: US 2002/0014171 A1
(43) Pub. Date: Feb. 7, 2002

(54) SHORT INKING UNIT

(76) Inventors: ROBERT KONRAD, WIESENBACH (DE); PEER DILLING, FRIEDBERG (DE)

Correspondence Address: COHEN PONTANI LIEBERMAN AND PAVANE, 551 FIFTH AVENUE, SUITE 1210, NEW YORK, NY, 10176

(21) Appl. No.: 09/119,104

(22) Filed: Jul. 20, 1998

(30) Foreign Application Priority Data
Jul. 18, 1997 (DE) 197 31 003.6

(51) Int. Cl. B41F 31/00

(52) U.S. Cl. 101/350.1

(57) ABSTRACT

A short inking unit in which, on the one hand, the ink film applied to a form cylinder by at least one ink application roll is smoothed by smoothing rolls and, on the other hand, ink untaken by the printing form on the form cylinder and fed back from an ink application roll causes no templating behavior. Either the printing ink is wiped from the ink application roll or the diameter of the ink application roll corresponds to that of the form cylinder. When there are two ink application rolls with the same circumference as the form cylinder, a secondary ink path can also be set.

### BACKGROUND OF THE INVENTION

1. Field of the Invention

The invention relates to a short inking unit with at least one ink application roll for applying ink to a form cylinder.

2. Discussion of the Prior Art

Inking units are used to ink form cylinders in rotary or sheet-fed offset printing machines. So-called “long” inking units, which have a plurality of rolls arranged either in series or parallel to one another, are known. The large number of rolls in such units is meant to ensure good distribution of the printing ink on the form cylinder. The large number of rolls is also meant to produce an ink layer of defined thickness, which maintains good evenness on the form cylinder during continuous printing. In this way, system-immanent errors, such as templating behavior, are to be reduced. Templating behavior leads to ghost effects on the print stock and ink waste on the printed product, and differences in ink density arise. Attempts to improve unsatisfactory printing results involve the use of ink distributor rolls and the deliberate control of the distribution timepoint. In addition, the number of ink application rolls and intermediate rolls is increased, and their arrangement and size are changed. Efforts are also made to compensate for inking unit errors statistically. However, none of these measures suffices to eliminate all of the defects. Rather, the inking unit becomes even more complicated due to the additional rolls.

Another problem is the fill characteristic of the inking unit. The more ink application rolls and ink transfer rolls an inking unit has, the more time it needs to allow its ink application rolls to emit the desired quantity of ink to the form cylinder. A great deal of spoilage is therefore produced before the inking unit achieves a steady state. This problem is especially great in the case of low ink taking. Because of ink storage in the inking unit, it is necessary to adjust the supply of ink by zones. This is done by means of ink zone screws, which allow dosing gaps of varying width to be set between an ink duct roll and inking blades. The storage effect is caused by the fact that ink application rolls create a thicker layer at the points where less printing ink is taken by the form cylinder than at the points where the form cylinder takes more ink. In the steady state, the ink application roll then has a relatively thicker ink layer at the locations where less printing ink was taken than at other locations, and thus provides the corresponding ink-taking points on the form cylinder with a disproportionally large amount of ink.

Short inking units are used in rotary offset printing machines for printing newspapers. These short inking units have a low number of rolls. Due to the low number of splitting points for ink splitting between rolls, the disadvantage arises that the printing ink emulsifies poorly with the wetting agent. In addition, the consistency of the ink is disrupted by the disproportionate back-splitting of ink into the ink duct. This often leads to blurred images and to a defective ink and water balance. Present-day short inking units also have very few ways to vary layer thickness.

In future printing machines, interventions to optimize quality will be carried out mainly in the digital data set, without influence being exercised on mechanical components inside the printing machine, for example, by the positioning of adjustment screws or by means of high-speed curves. In printing machines thus oriented toward image data, interventions can be carried out on prestage data or in the raster image processor (RIP). An inking unit developed for such printing machines must therefore be characteristic-stable, so that printing-unit-specific errors during imaging can be compensated for by influencing the digital data, and the printing quality does not change, even during continuous printing.

German reference DE 33 24 382 C2 discloses an inking unit for direct or indirect flat-bed printing. Here, an ink-repellent smoothing roll is positioned on the form cylinder. The inking unit in this case, however, is not a short inking unit, but rather has a large number of rolls. German references DE 44 24 920 A1 and DE 94 21 322 U1 disclose inking units for water-free offset printing. These units have two application rolls with a smaller circumference than the form cylinder. Printing inks treated with separating agents are used for printing. The printing plate has ink-friendly and separating-agent-friendly locations. The separating agent is ink-repellent and causes the non-printing areas of the flat water-free printing plate not to be printed. In the running direction, the plate cylinder is first moistened by the separating-agent-friendly application roll and then by the ink-friendly application roll. The former emits the separating agent to the non-printing locations of the plate cylinder, while the latter provides ink to the printing locations. In this way, it is ensured that both the printing ink and the separating agent reach the printing plate on the form cylinder.

### SUMMARY OF THE INVENTION

Accordingly, it is an object of the present invention to provide a short inking unit with a low number of inking unit rolls and, at the same time, to ensure an even, homogeneous application of ink to the form cylinder.

Pursuant to this object, and others which will become apparent hereafter, one aspect of the present invention resides in a short inking unit comprised of a form cylinder, an ink application roll for applying printing ink to the form cylinder, and at least one smoothing roll arranged to rest on the form cylinder.

In another embodiment of the invention a blade is positioned on the at least one smoothing roll.

In still a further embodiment of the invention the smoothing roll has a completely ink-repellent surface.

In still another embodiment of the invention an ink transfer roll is arranged to supply ink to the ink application roll. A blade is positioned on the ink application roll so as to wipe off printing ink not taken at a splitting point between the ink application roll and the form cylinder.

In still a further embodiment of the invention the ink application roll and the form cylinder are equal in circumference.

Yet another embodiment of the invention provides an additional ink application roll. Both of the ink application rolls are ink-friendly and positioned on the form cylinder.

Still a further embodiment provides a single ink transfer roll arranged to supply ink to both of the ink application rolls.

The short inking unit created by the invention has no inking zones and is therefore easy to operate. With the short inking unit according to the invention, templating behavior is avoided with simple means. Further, ink spoilage is avoided over the length of the printing form. The short inking unit can be filled in a very short time, and the ink is distributed evenly over the surface. When a wetting agent is used, a stable ink-water balance can be attained, although few rolls are used. Thus, a stable and even inking quality is attained over time, over the width of the printing form and over its entire surface. The inking unit is constructed simply, and the number of operational elements is reduced to a minimum. The printing machine can thus be operated even by untrained personnel. Individual structural components, e.g., individual inking unit rolls, can be easily exchanged. Moreover, the energy requirements for a short inking unit with a lower number of rolls are lower than for an inking unit with a large number of rolls. The short inking unit is suitable both for indirect and for direct printing. It can be used for printing processes in which a wetting agent is used as well as in water-free printing processes.

According to the invention, more ink application rolls are preferably used on the circumference of the form cylinder than between the ink duct and the form cylinder. This can be referred to as a “tangential” arrangement of inking unit rolls, in contrast to the “orthogonal” arrangement of a large number of rolls between the ink duct and the form cylinder characteristic of classic long inking units.

According to the invention, an even and homogeneous ink application is attained on the print stock, even at higher ink layer thicknesses.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

The drawings show:

FIG. 1 shows a first embodiment of a short inking unit pursuant to the present invention;

FIG. 2 shows a second embodiment of a short inking unit;

FIG. 3 shows a third embodiment of a short inking unit;

FIG. 4 has a view similar to FIG. 1 of a fourth embodiment;

FIG. 5 shows a fifth embodiment;

FIG. 6 shows a sixth embodiment;

FIG. 7 shows a seventh embodiment;

FIG. 8 shows an eighth embodiment;

FIG. 9 shows a ninth embodiment;

FIG. 10 shows a tenth embodiment;

FIG. 11 shows a eleventh embodiment;

FIG. 12 shows a twelfth embodiment;

FIG. 13 shows a thirteenth embodiment;

FIG. 14 shows a fourteenth embodiment;

FIG. 15 shows a fifteenth embodiment;

FIG. 16 shows a sixteenth embodiment;

FIG. 17 shows a seventeenth embodiment;

FIG. 18 shows an eighteenth embodiment;

FIG. 19 shows a nineteenth embodiment;

FIG. 20 shows a twentieth embodiment;

FIG. 21 shows a twenty-first embodiment;

FIG. 22 shows a twenty-second embodiment;

FIG. 23 shows a twenty-third embodiment; and

FIG. 24 shows a twenty-fourth embodiment.

### DETAILED DESCRIPTION OF THE PREFERRED EMBODIMENTS

A short inking unit (FIG. 1) for an offset printing machine has an application roll 1, which rotates in an ink duct 2 filled with printing ink and takes printing ink from the duct 2. The ink application roll 1 transfers the printing ink to a form cylinder 3, which is equipped with at least one printing form. In indirect printing, the form cylinder 3 interacts with a transfer cylinder 4 (rubber-blanket cylinder). In direct printing, in which the short inking unit described below can also be used, the transfer cylinder 4 is omitted. A smoothing roll 5 is also positioned against the form cylinder 3. The smoothing roll 5 serves to smooth the printing ink applied by the ink application roll 1 to the form cylinder 3. Printing ink taken along by the smoothing roll 5 after its contact with the form cylinder 3 is wiped off by a blade 6. The smoothing roll 5 has either an ink-friendly or an ink-repellent surface. If the smoothing roll 5 is embodied as an ink-friendly smoothing roll, it smooths the ink film through the ink split at the point where the smoothing roll 5 contacts the form cylinder 3. The smoothing roll 5 has a surface that picks up either very little or no ink. If the smoothing roll does pick up some ink, a blade must be provided. Without wiping, a stationary ink layer would form on the smoothing roll 5, and an ink layer with a fleece-like structure would form on the form cylinder 3 at the ink split between the smoothing roll 5 and the form cylinder 3.

The blade 6 provides continuous ink removal. Preferably, the wiped-off ink can be resupplied to the ink duct 2. The continuous ink removal prevents emulsification of the printing ink on the smoothing roll 5. The blade 6 is a positive, neutral or negatively positioned blade, for example. If the blade 6 is positively positioned, it can be embodied as a blade that floats on the ink film. The ink film is then smoothed by means of spreading. A negatively positioned blade 6 can also be arranged in floating fashion, if it is chamfered. A gap of 2 to 5 μm, for example, is then maintained between the blade 6 and the smoothing roll 5. The blade 6 is adjusted (e.g., by a piezo actuator) relative to the surface of the smoothing roll 5 in such a way as to set the aforementioned gap. If the blade 6 is a negatively positioned blade, it is positioned onto the circumferential surface of the smoothing roll 5 under pressure, so that all printing ink is removed from the circumferential surface. When the smoothing roll 5 has a completely ink-repellent surface, the use of the blade 6 is optional. On the other hand, if the smoothing roll has a surface that absorbs ink to some extent, the blade 6 is required in all cases.

The short inking unit shown in FIG. 2 is constructed like that shown in FIG. 1, but has an additional smoothing roll 7, from which the printing ink is wiped via a blade 8.

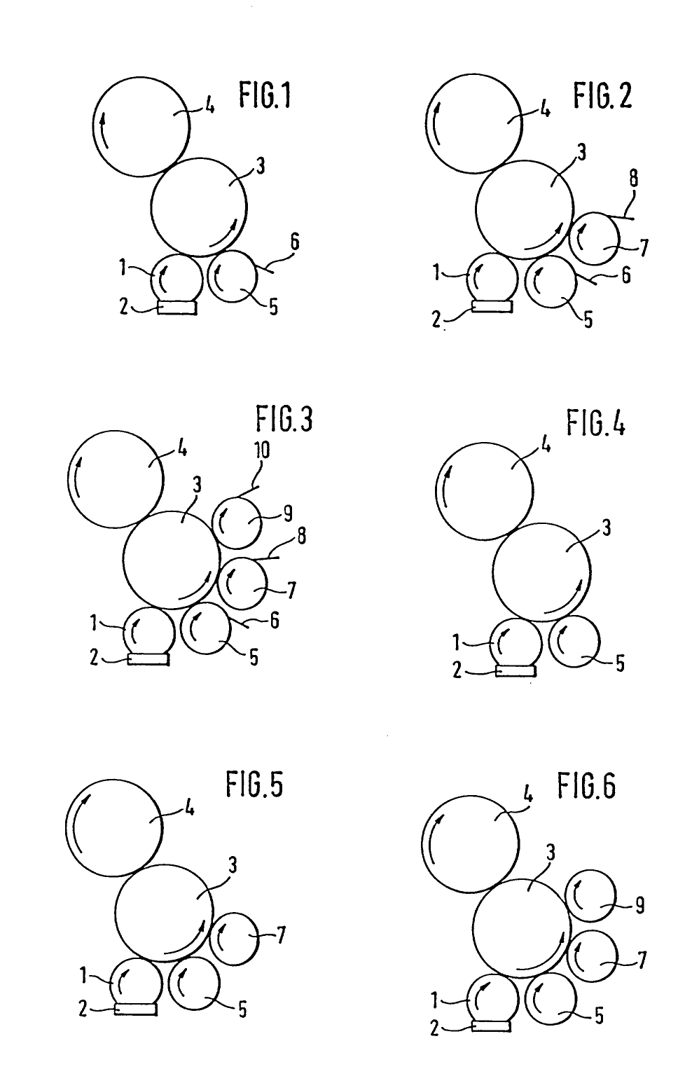

The short inking unit shown in FIG. 3 has three smoothing rolls 5, 7, 9, from which the printing ink is wiped by the respective blades 6, 8, 10.

In another example (FIG. 4), the short inking unit has only a single smoothing roll 5, on which no blade 6 is positioned. In this case, the smoothing roll 5 has a completely ink-repellent circumferential surface that consists, for example, of silicone rubber, fluorosilicone rubber or of polytetrafluoroethylene. Here, the ink relief on the printing form of the form cylinder 3 is smoothed by means of pressure and squeezing. The printing ink is prevented from resplitting at the contact point between the form cylinder 3 and the smoothing roll 5 by the ink-repellent covering.

FIGS. 5 and 6 show short printing units with a plurality of ink-repellent smoothing rolls 5, 7 and 5, 7, 9.

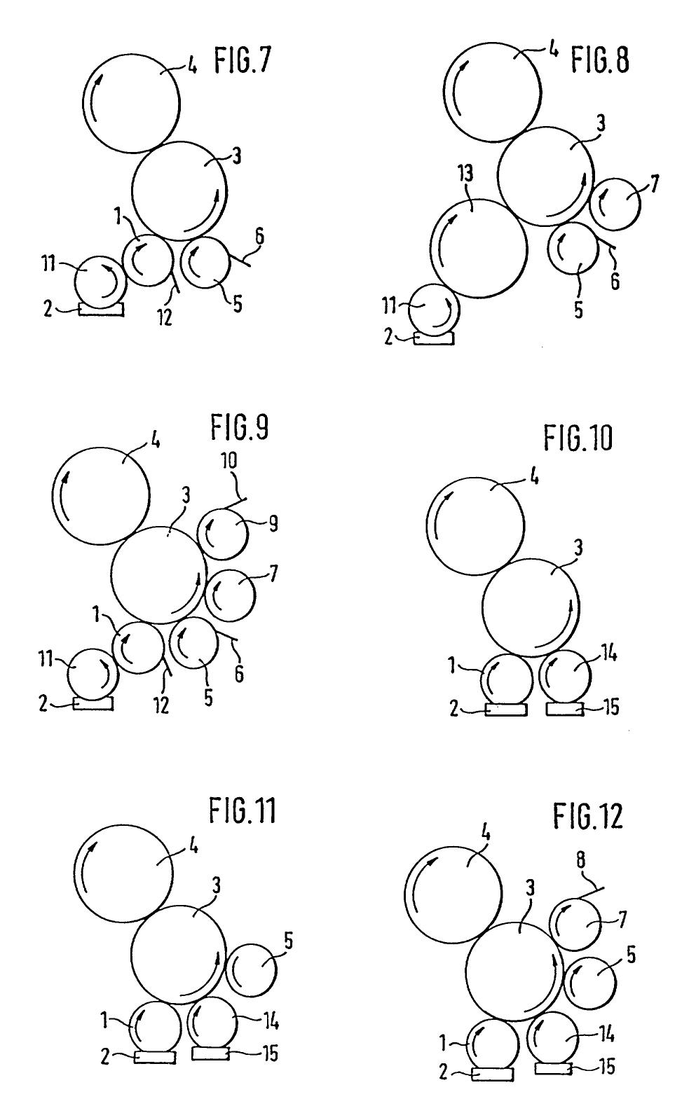

In another example (FIG. 7), the ink layer is produced not on the ink application roll 1, but rather on a preferably hard ink transfer roll 11, which is a hard ceramic roll with a smooth or a rough surface, for example, and can be a screen or hashing roll. The ink transfer roll 11 rotates in the ink duct 2 and transfers printing ink to the ink application roll 1. To avoid the return of printing ink that was not taken by the form cylinder 3 at the ink split between the ink application roll 1 and the form cylinder 3, a blade 12 is positioned on the ink application roll 1.

In another example (FIG. 8), an ink application roll 13 has the same circumference as the form cylinder 3. As a result, the use of a blade 12 on the ink application roll 13 is unnecessary in this case. Printing ink that is fed back from the ink application roll 13 to the ink transfer roll 11 and remains on the circumferential surface of the ink application roll 13 strikes the printing form on the circumferential surface of the form cylinder 3 in a subject-true manner, so that ghosting cannot occur. The buildup of printing ink on the ink application roll 1 or 13, to which the printing ink is applied via an ink transfer roll 11, is thus avoided, either because the returned ink is wiped off by a blade 12 or because the ink application roll 13 has the same circumference as the form cylinder 3.

The example in FIG. 9 corresponds to that in FIG. 7. The short inking unit in FIG. 9 again has smoothing rolls 5, 7, 9 (as in FIG. 3, also). Each smoothing roll 5, 7, 9 is preferably equipped with a blade 6, 10. However, if the smoothing roll 7 is completely ink-repellent, no blade is necessary.

In another example (FIG. 10), there is an ink application roll 1 that rotates in an ink duct 2, as in FIG. 1. In addition, there is an identically-constructed ink application roll 14 that rotates in an ink duct 15. In this example, as well as in all others, the ink applications rolls 1, 14 are ink-friendly. If the ink application roll 1, 14 rotates in the ink duct 2 or 15, as is the case here and in FIGS. 1 to 6, no return of the printing ink that remains on the ink application roll 1, 14 at the ink split between the form cylinder 3 and the ink application roll 1, 14 is possible, because the ink application roll 1, 14 is again covered completely with an even layer of ink in the ink duct 2, 15.

In FIGS. 11 and 12, there is either a single ink-repellent smoothing roll 5 or a smoothing roll 5 and a further smoothing roll 7 with a blade 8. The smoothing roll 7 can also be ink-friendly.

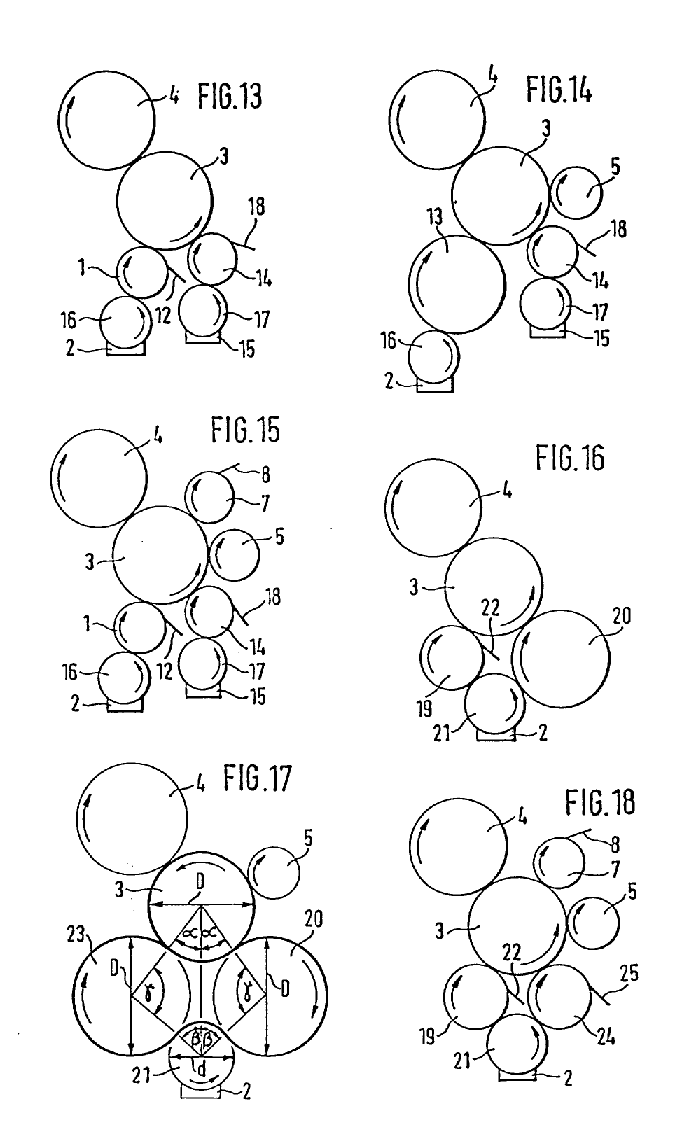

In another example (FIG. 13), the printing ink is transferred to the form cylinder 3 via two ink application rolls 1, 14, which are themselves inked by ink transfer rolls 16 or 17 that rotate in the ink duct 2, 15. Because the ink application rolls 1, 14 do not have the same circumference as the form cylinder 3, the ink application rolls 1, 14 are wiped off by the blades 12, 18, so as to avoid ghost effects on the form cylinder 3. In other words, all ink residues are removed from the circumferential surfaces of the ink applications rolls 1, 14 by the blades 12, 18, so that the rolls 1, 14, after taking ink at the split point with the ink transfer rolls 16, 17, have an even ink layer thickness over their entire circumferential surface when contacting the form cylinder 3. Or, instead of removing all printing ink by means of the blades 12, 18, it is also possible to attain an even ink layer by spreading the printing ink with the help of properly angled blades 12, 18 with proper positioning force.

One or both ink application rolls 1, 14 can be replaced by a circumferential-sized ink application roll 13 (FIG. 14). In addition, there is at least one smoothing roll 5 that, if it has no blade, is ink-repellent.

It is also possible to have several smoothing rolls, for example, two smoothing rolls 5, 7 (FIG. 15), with a blade 8 arranged on the smoothing roll 7.

An ink application roll 19 (FIG. 16) that is smaller than the form cylinder 3 and an ink application roll 20 with the same circumference as the form cylinder 3 are inked by a single ink transfer cylinder 21. On the ink-returning side of the ink application roll 19, there is a blade 22. As a result, during subsequent inking of the ink application roll 19 by the ink transfer roll 21, any residual printing ink not taken by the form cylinder 3 is overlaid by the new ink layer.

If there are two circumference-sized ink application rolls 20, 23 (FIG. 17), the use of the blade 22 is not necessary. The ink film applied to the form cylinder 3 by the ink application rolls 20, 23 can, in addition, be smoothed by a smoothing roll 5.

If there are two ink application rolls 19, 24 (FIG. 18) with a circumference smaller than that of the form cylinder 3, each must be wiped by a blade 22 or 25 on the ink-returning side. In addition, there can be smoothing rolls 5, 7. At least when the smoothing rollers 5, 7 are not completely ink-repellent, they must be wiped by a blade 8.

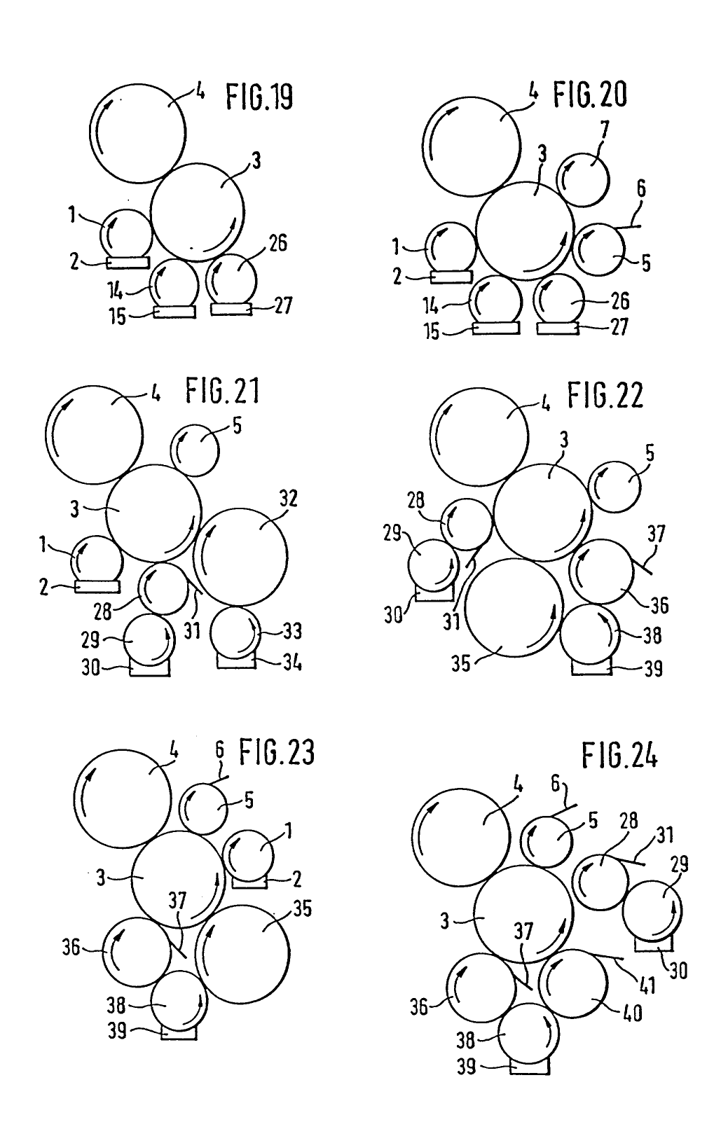

Instead of two ink application rolls 1, 14 (FIG. 1), there can be further ink application rolls, for example, an ink application roll 26 (FIG. 19) that rotates in an ink duct 27.

When there are three ink application rolls 1, 14, 26, as in FIG. 19, smoothing rolls 5, 7 (FIG. 20) can be provided, whereby a blade 6, 8 must be provided at least when the smoothing rolls 5, 7 are not completely ink-repellent.

In another example (FIG. 21), in addition to the ink application roll 1, there is an ink application roll 28, which obtains its printing ink from an ink transfer roll 29. The ink transfer roll 29 rotates in an ink duct 30 and obtains its ink layer directly therein. Positioned on the ink application roll 28 is a blade 31. A circumference-sized ink application roll 32 is supplied with ink via an ink transfer roll 33 that rotates in an ink duct 34. A smoothing roll 5 is positioned on the form cylinder 3.

In another example (FIG. 22), in addition to the ink application roll 28, ink application rolls 35 and 36 are positioned on the form cylinder 3. The ink application roll 35 has the same circumference as the form cylinder 3. Because the ink application roll 36 has a smaller circumference than the form cylinder 3, it is necessary to arrange a blade 37 on the ink-returning side. The ink application rolls 35, 36 are both inked by an ink transfer roll 38, which rotates in an ink duct 39. A smoothing roll is positioned on the form cylinder 3.

Instead of the ink application roll 28 that interacts with the ink transfer roll 29, the ink application roll 1 (FIG. 23) can be positioned on the form cylinder 3, in connection with the ink application rolls 35, 37. In this example, a blade 6 is positioned on the smoothing roll 5.

Instead of the circumference-sized ink application roll 35, a small ink application roll 40 (FIG. 24) can be used, which, like the ink application roll 36, is inked by the ink transfer roll 38. A blade 41 is provided on the ink application roll 40. The ink application roll 28 is used, in conjunction with the ink transfer roll 29, as the third ink application roll. In addition, the smoothing roll 5 with a blade 6 is arranged on the form cylinder 3. Of course, many other combinations can be obtained by combining the features of the above examples or by exchanging individual components for other components.

It is crucial according to the invention that, at least when the ink application roll has a smaller circumference than the form cylinder 3 and does not itself rotate in the ink duct, the printing ink not absorbed by the form cylinder 3 be removed on the ink-returning side. Alternatively, the diameter of the ink application roll can correspond to the diameter of the form cylinder 3. It is thereby vital that the effective diameter of the ink application roll correspond to the diameter of the form cylinder. Thus, when the ink application roll has a soft circumferential covering, e.g., a rubber layer, as is generally the case in indirect printing, bulge formation at the contact point with the form cylinder 3 must be taken into account in determining the effective circumference and effective diameter of the ink application roll. The expansion of the circumference layer creates a larger circumference for the ink application roll than the latter actually has. To take into account this expansion, the circumference of the ink application roll must be designed in advance to be somewhat smaller than the circumference of the form cylinder 3. These measures, all of which are aimed at ensuring correct rolling between the form cylinder 3 and the ink application roll at all times, make it possible to create an inking unit without ink zone divisions.

In addition to or in conjunction with these measures, smoothing rolls that are either wiped on their back side or are completely ink-repellent are provided. (If a smoothing roll already has an ink-repellent circumferential surface, it is not necessary to provide a blade.) Blades can be positioned positively, negatively or neutrally on the rolls in question. Ink-repellent materials suitable for the circumferential surface of a smoothing roll include silicone rubber, polytetrafluoroethylene and other compounds of similar composition, for example.

A smoothing roll can also attain an ink-repellent effect by being supplied with a separating agent, e.g., a silicone oil, or a wetting agent. If a blade is provided on the smoothing roll, the blade can be positioned positively, negatively or neutrally on the roll. A positively positioned blade can be pressed against the circumferential surface of the smoothing roll so that a predetermined gap, e.g., from 2 to 5 μm thickness, is created between the blade and the smoothing roll. In this way, an even ink layer thickness can be attained on the form cylinder 3. It is also possible, however, for a blade to be positioned firmly on the circumferential surface of the smoothing roll in such a way as to remove all printing ink therefrom. A piezo actuator can serve to set the gap width or to press the blade onto the smoothing roll.

To reduce spoilage, improve print quality and simplify operation, it is especially advantageous for the printing ink in the ink ducts 2, 15, 27, 30, 34, 39 to be preconditioned. This means that an emulsion of printing ink and wetting agent or separating agent, which emulsion has been mixed with the printing ink outside of the ink duct 2, 15, 27, 30, 34, 39 by means of a stirring device or ultrasound, is provided in the ink ducts 2, 15, 27, 30, 34, 39. This emulsification prevents heat from developing inside the ink duct. The droplets of separating or wetting agent preferably have a diameter of approximately 1 μm. The percentage of separating agent or wetting agent in the printing ink is between 20% and 30%, for example.

To ensure freedom from templating behavior in multiple ink application rolls connected to each other by an ink transfer roll, e.g, the ink transfer roll 21 or 38, it is necessary for the ink application rolls to have the same circumference as the form cylinder 3 or for the application rolls to be wiped on the ink-returning side. In the first case, the ink split off from the form cylinder, after rotation of the form cylinder, again strikes the same location on the ink application roll that participated in this split. The ink application roll can also have an effective diameter that corresponds to any desired whole-number multiple of the form cylinder diameter. The path that the printing ink travels on an ink application roll from the split point to the form cylinder until again striking the form cylinder can be described as the “primary ink path.”

Thus, primary ink paths can be established by the effective diameter of the ink application roll(s) being equal to the diameter of the form cylinder. If no slip occurs between the ink application roll and the form cylinder, i.e., if drive is carried out purely by means of friction or if the ink application rolls are driven at the same speed as would prevail were friction being used, then the effective diameter of the preferably soft ink application roll should equal the circumference of the form cylinder. The effective diameter of the ink application roll depends on the print-off width between the ink application roll and the form cylinder, which is calculated by measuring the respective speeds of the form cylinder and the ink application roll. The ratio of the speed of the ink application roll to the speed of the form cylinder, multiplied by the diameter of the form cylinder, then yields the effective diameter of the ink application roll.

When there are two ink application rolls 20, 23 (cf. FIG. 17), templating can nonetheless occur unless additional blades are arranged on the ink application rolls 20, 23. The residual printing ink left on the ink application roll after splitting at a split point between the form cylinder and the first ink application roll could migrate back to the form cylinder 3 via the ink transfer roll 21 and the second ink application roll. This is the “secondary ink path.” To ensure freedom from templating behavior, all ink paths must therefore be whole-number multiples of the form cylinder circumference. For the primary ink path, this means that its length corresponds to the circumference of the form cylinder 3, so that the primary ink path is adjusted by virtue of the effective diameter D of the ink application roll (e.g., the ink application roll 20 or 23 in FIG. 17) corresponding to the diameter D of the form cylinder. The secondary ink path corresponds to twice the form cylinder circumference.

If a connecting line is drawn between the form cylinder 3 and the ink transfer roll 21, and a connection is also made between the midpoint of the form cylinder 3 and the ink application roll 20 or between the midpoint of the form cylinder 3 and the midpoint of the ink application roll 23, then the latter two connecting lines respectively form an angle α with the connecting line between the midpoint of the form cylinder 3 and the midpoint of the ink transfer roll 21. If the connecting lines between the midpoints of the ink application rolls 20, 23 and the midpoint of the ink transfer roll 21 form an angle 2 β and if the connecting lines between the midpoints of the ink application rolls 20, 23 and the midpoint of the form cylinder 3 respectively form an angle γ with the connecting lines between the midpoints of the ink applications rolls 20, 23 and the midpoint of the ink transfer roll 21, then the following formula for the secondary ink path must be met to avoid templating behavior:

2 π* D=(2 π−γ) D+β d+α D

where d is the diameter of the ink transfer roll 21. In the formula, all angles are to be used in radian measure; π refers to the circle number.

Slip can occur between the ink transfer roll 21 and the respective ink application rolls 20, 23. It then holds that the effective diameter d of the ink transfer roll 21 is equal to the ratio of the speed of the ink transfer roll 21 to the speed of the form cylinder 3, multiplied by the diameter of the form cylinder 3.

The invention provides a short inking unit in which, on the one hand, the ink film applied to a form cylinder 3 by at least one ink application roll 1, 14 is smoothed by smoothing rolls 5, 7 and, on the other hand, ink untaken by the printing form on the form cylinder 3 and fed back from an ink application roll 1, 14 causes no templating behavior. This is ensured by the fact that either the printing ink is wiped from the ink application roll 1, 14 or the diameter of the ink application roll corresponds to the diameter of the form cylinder 3. When there two ink application rolls 20, 23 with the same circumference as the form cylinder 3, a secondary ink path can also be set.

The ink transfer roll 11, 16, 17, 21, 29, 33, 38 has either a smooth or a rough circumferential surface and is, for example, a screen roll or has hashing on its circumferential surface. In particular, it can also be ceramic.

The measures according to the invention make it possible to create ink layers of various thicknesses to meet higher quality requirements. All known inking-unit-specific defects and disadvantages in long inking units are omitted or eliminated by the short inking unit.

The invention is not limited by the embodiments described above which are presented as examples only but can be modified in various ways within the scope of protection defined by the appended patent claims.

We claim:

1. A short inking unit comprising:
a form cylinder;
an ink application roll arranged so as to apply printing ink to the form cylinder; and
at least one smoothing roll arranged to rest on the form cylinder.

2. A short inking unit as defined in claim 1, and further comprising a blade positioned on the at least one smoothing roll.

3. A short inking unit as defined in claim 1, wherein the smoothing roll has a completely ink-repellent surface.

4. A short inking unit as defined in claim 1, wherein an ink-repellent agent is applied to an outer surface of the smoothing roll.

5. A short inking unit as defined in claim 1, and further comprising an ink duct, the ink application roll being arranged to take printing ink directly from the ink duct.

6. A short inking unit as defined in claim 1, and further comprising an ink transfer roll arranged to supply ink to the ink application roll, and a blade positioned on the ink application roll so as to wipe off printing ink not taken at a splitting point between the ink application roll and the form cylinder.

7. A short inking unit as defined in claim 1, wherein the ink application roll has a circumference equal to a circumference of the form cylinder.

8. A short inking unit as defined in claim 1, and further comprising an additional ink application roll, the ink application rolls being ink-friendly and positioned on the form cylinder.

9. A short inking unit as defined in claim 8, and further comprising two ink ducts, each of the ink application rolls being arranged to take printing ink directly from a respective one of the ink ducts.

10. A short inking unit as defined in claim 8, and further comprising two ink transfer rolls, each of the ink application rolls being arranged to take printing ink from a respective one of the ink transfer rolls, and still further comprising two blades, each of the blades being positioned on a respective one of the ink application rolls.

11. A short inking unit as defined in claim 8, wherein at least one of the ink application rolls has a circumference equal to a circumference of the form cylinder.

12. A short inking unit as defined in claim 8, and further comprising an ink transfer roll arranged to supply ink to both of the ink application rolls, the ink application rolls having a circumference equal to a circumference of the form cylinder.

13. A short inking unit as defined in claim 8, wherein at least one of the ink application rolls have a circumference different from a circumference of the form cylinder, and further comprising an ink transfer roll arranged to supply ink to both of the ink application rolls, and a blade positioned on the ink application roller behind a split point with the form cylinder.

14. A short inking unit as defined in claim 7, wherein more than two ink application rolls are positioned on the form cylinder.

15. A short inking unit as defined in claim 12, wherein the form cylinder, the ink transfer roll and the ink application rolls are arranged so that a midpoint of the form cylinder forms a first angle (2 α) with midpoints of the ink application rolls, a midpoint of the ink transfer roll forms a second angle (2 β) with the midpoints of the ink application rolls, and the midpoints of the ink application rolls respectively form a third angle (γ) with the midpoint of the form cylinder and the midpoint of the ink transfer roll, wherein for a second ink path, it holds that:
2 π* D=(2 π−γ) D+β d+α D
where D is the diameter of the form cylinder and d is the diameter of the ink transfer roll.

16. A short inking unit as defined in claim 1, and further comprising an ink duct arranged to supply ink to the ink application roll, the ink duct containing an emulsion of printing ink and one of wetting agent and separating agent.

17. A short inking unit as defined in claim 6, wherein the ink transfer roll has a smooth circumferential surface.

18. A short inking unit as defined in claim 6, wherein the ink transfer roll has a rough circumferential surface.

19. A short inking unit as defined in claim 6, wherein the ink transfer roll has a hashed circumferential surface.

20. A short inking unit as defined in claim 6, wherein the ink transfer roll is a screen roll.

21. A short inking unit as defined in claim 6, wherein the ink transfer roll has a ceramic outer circumference.

22. A short inking unit as defined in claim 4, wherein the ink-repellent agent is one of a wetting agent and a separating agent.
